(19) United States
(12) Patent Application Publication
(10) Pub. No.: US 2016/0137843 A1
(43) Pub. Date: May 19, 2016

(54) RECYCLED ROOM-TEMPERATURE ASPHALT COMPOSITION AND ROAD PAVING METHOD

(71) Applicant: SHINSUN INC., Gangwon-do (KR)

(72) Inventor: Han Seok JEON, Gangwon-do (KR)

(73) Assignee: SHINSUN INC., Gangwon-do (KR)

(21) Appl. No.: 14/899,115

(22) PCT Filed: Feb. 26, 2015
(86) PCT No.: PCT/KR2015/001880

§ 371 Date: Dec. 16, 2015

(30) Foreign Application Priority Data
Feb. 27, 2014 (KR) 10-2014-0023264

(51) Int. Cl. C08L 95/00; E01C 19/48; E01C 23/06; E01C 7/00

(52) U.S. Cl. CPC C08L 95/00; E01C 7/00; E01C 19/48; E01C 23/065

(57) ABSTRACT

The present invention provides a recycled room-temperature asphalt composition characterized by comprising: 60-93 wt % of asphalt concrete recycled aggregates; 0.1-30 wt % of new aggregates or recycled aggregates for concrete; and 2-5 wt % of a limestone powder, and a road paving method using the same, thereby increasing resource recycling and resource saving effects, exhibiting environmental characteristics due to the non-generation of green-house gases and harmful gases, allowing immediate pavement construction at room temperature, facilitating pavement construction even when the pavement surface is humid, reducing the duration of works, reducing construction costs, allowing early opening after the pavement construction, improving fluidity, adhesion, chemical resistance, and cracking resistance, and maximizing durability and performance through the reduction in the drying shrinkage.

### TECHNICAL FIELD

The present invention relates to a material for civil engineering, more specifically to a recycled room-temperature asphalt composition and a method for paving a road using the same.

### BACKGROUND ART

Recently, roads in Korea have already reached their saturation point as congestion occurs more frequently due to heavy traffic caused by rapid increase in distribution and increase in the number of heavy vehicles.

Accordingly, a huge amount of waste asphalt concrete is generated by expansion, pavement, and surface milling of roads. Therefore, a way of recycling the waste asphalt concrete becomes an important issue.

Also, a great deal of costs and time is required for maintaining and repairing road pavement, and also in order to supply new materials, a huge amount of material resources and energy is brought to extract aggregates. The continuous and indiscriminate use of aggregates triggers numerous issues and raises severe problems including environmental destruction and resource exhaustion.

In order to resolve these issues, conventionally, methods associated with recycled hot asphalt mixtures and hot-in place surface recycling methods, etc., have been developed for recycling waste asphalt concrete.

However, these methods require high costs for manufacturing facilities. Further, the construction according to these methods is to be performed by heating at a high temperature, not at room temperature. Accordingly, fuel costs would increase due to the heating, and large amounts of harmful gases and carbon dioxide would be generated. Additionally, the pavement construction according to these methods is complex, and asphalt is oxidized and aged due to heating, which results in scaling and cracking of the mixtures. Accordingly, these methods are disadvantageous in durability and performance in the road pavement.

Recently, as a way of resolving these issues, a recycled room-temperature asphalt concrete mixture is used.

Conventional recycled room-temperature asphalt concrete mixtures use materials reactable with cement and water as a material of a filler.

The filler follows the filler material standards for pavement prescribed in “GR F 4026:10 Recycled room-temperature asphalt concrete mixture, Section 5.2.”

However, for the substratum of roads, emulsified asphalt is to be used, which is not suitable for the standards for the use of filler, and cracking, scaling, and removing would occur after construction due to the hydration reaction of cement.

Also, in the case of overlaying an upper layer (middle layer, surface layer) onto the top of the recycled room-temperature asphalt concrete mixture, the surface adhered to the upper layer is separated due to poor adhesion. This leads to main causes of damage to pavement, such as reflective cracking, slippage cracking, fatigue cracking (turtle back cracking), etc.

In other words, conventional recycled room-temperature asphalt concrete mixtures, which use a filler reactable with cement and water, simply enclose aggregate particles after pavement, and do not serve as a filler filling pores, which is an important quality property of mixtures.

Accordingly, excessive pores cause an increase in coefficient of permeability, thereby resulting in weakening of durability by aging, cracking, removing, early generation of potholes, etc.

### SUMMARY OF THE INVENTION

The present invention was invented in order to solve the above problems. It is an object of the present invention to provide a recycled room-temperature asphalt composition and a method for paving a road using the same, thereby increasing resource recycling and resource saving effects, exhibiting environment-friendly characteristics without generating green-house gases and harmful gases, allowing immediate pavement construction at room temperature, facilitating pavement construction even when the pavement surface is humid, shortening construction period, saving construction costs, allowing early opening after the pavement construction, improving fluidity, adhesion, chemical resistance, and cracking resistance, and reducing drying shrinkage, to maximize durability and performance.

In order to achieve the above matters, the present invention provides a recycled room-temperature asphalt composition, characterized by including 60 to 93% by weight of a recycled asphalt concrete aggregate; 0.1 to 30% by weight of a new aggregate or a recycled aggregate for concrete; and 2 to 5% by weight of a limestone powder.

The recycled room-temperature asphalt composition preferably further includes 3 to 7% by weight of a modified emulsified asphalt.

The modified emulsified asphalt preferably includes 40 to 55% by weight of pure asphalt.

The modified emulsified asphalt preferably includes an acrylic polymer emulsion asphalt, and the acrylic polymer emulsion asphalt preferably includes 1 to 5% by weight of an acrylic emulsion.

The recycled room-temperature asphalt composition preferably further includes 3.5 to 10% by weight of a cationic emulsified asphalt.

The cationic emulsified asphalt preferably includes 40 to 52% by weight of asphalt (AP-3); 1 to 1.3% by weight of an emulsifier; 0.1 to 1.15% by weight of calcium chloride; 0.01 to 0.15% by weight of hydrochloric acid; 45 to 55% by weight of water; and 1 to 3% by weight of an acrylic polymer emulsion.

The recycled room-temperature asphalt composition preferably further includes 1 to 3% by weight of an additive for reclamation.

The additive for reclamation preferably further includes 10 to 80% by weight of a solid carbon component.

The limestone powder preferably includes 51.1 to 54.8 parts by weight of CaO and 1.5 to 2.5 parts by weight of an additive with respect to a total weight.

The limestone powder preferably includes a Pungchon high-purity limestone micropowder.

The additive is preferably any one of Al₂O₃, SiO₃, Fe₂O₃, and MgO, or a mixture of at least two thereof

The present invention provides a method for paving a road with the recycled room-temperature asphalt composition, characterized by including the steps of preparing the recycled room-temperature asphalt composition; paving the recycled room-temperature composition on a new or a repair portion of road pavement, and compacting and curing the recycled room-temperature asphalt composition; and coating and curing a finishing material onto the top of the compacted recycled room-temperature asphalt composition.

The finishing material is preferably formed of any one of a modified emulsified asphalt formed of an acrylic polymer emulsion asphalt or a cationic emulsified asphalt, or a mixture of at least two thereof, and the finishing material is preferably coated in an amount of 0.1 to 2.0% by weight per unit area (m²/L) in the step of coating the finishing material.

The present invention provides a recycled room-temperature asphalt composition and a method for paving a road using the same, thereby increasing resource recycling and resource saving effects, exhibiting environment-friendly characteristics without generating green-house gases and harmful gases, allowing immediate pavement construction at room temperature, facilitating pavement construction even when the pavement surface is humid, shortening construction period, saving construction costs, allowing early opening after the pavement construction, improving fluidity, adhesion, chemical resistance, and cracking resistance, and reducing drying shrinkage, to maximize durability and performance.

### BRIEF DESCRIPTION OF DRAWING

FIG. 1 is a flow chart of a method for paving a road with a recycled room-temperature asphalt composition according to the present invention.

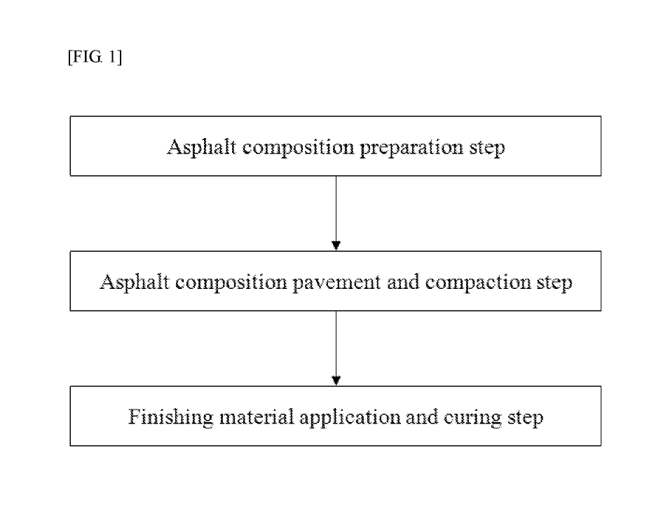

### BEST MODE FOR CARRYING OUT THE INVENTION

Hereinafter, embodiments of the present invention will be described in detail with reference to the accompanying tables.

As shown in Table 1 below, a recycled room-temperature asphalt composition according to the present invention is characterized by including 60 to 93% by weight of a recycled asphalt concrete aggregate; 0.1 to 30% by weight of a new aggregate or a recycled aggregate for concrete; and 2 to 5% by weight of a limestone powder.

Table 1 shows the composition ratio of the above components.

TABLE 1

| Component | Composition ratio (wt %) |
|---|---|
| Recycled asphalt concrete aggregate | 60 to 93 |
| New aggregate or recycled aggregate for | 0.1 to 30 |
| concrete | |
| Limestone powder | 2 to 5 |
| Modified emulsified asphalt | 3 to 7 |

The recycled room-temperature asphalt composition according to the present invention, which is a composition used for road pavement, for industrial complex pavement, and for ground pavement of civil engineering or construction works, is provided to resolve the problems of conventional room-temperature asphalt concrete mixtures.

The following effects may be achieved by the recycled room-temperature asphalt composition of the present invention.

First, the recycled room-temperature asphalt composition according to the present invention allows immediate construction at room temperature without a separate heating process, shortens construction period due to short curing period without mixing cement and water, which are conventionally used, increases constructability, and saves construction costs thereby.

Second, the recycled room-temperature asphalt composition according to the present invention has resource recycling and resource saving effects by reclaiming waste asphalt concrete, does not generate green-house gases and harmful gases due to the production by a non-thermal process for not using coal fuel, and exhibits environment-friendly effects with no environmental contamination caused by dust generation after construction by using a room-temperature mixing construction process.

Third, the recycled room-temperature asphalt composition according to the present invention secures fluidity of asphalt, increases binding between aggregates, thereby improving adhesion, reinforces resistance to moisture, thereby raising resistance to drying shrinkage, scaling resistance, and cracking resistance, and prevents plastic deformation, thereby improving durability and performance of road pavement.

Fourth, the recycled room-temperature asphalt composition according to the present invention allows early opening of roads after pavement construction, and thus is preferable in terms of usability and stability of roads.

Fifth, a method for construction with the asphalt composition according to the present invention includes coating a finishing material in order to secure a pavement with excellent adhesion, physical stability, chemical resistance, and excellent oil resistance to oil components of roads.

Thereby, the composition according to the present invention has the effects of generating no dust after construction and thus causing no environmentally harmful elements, and facilitating construction even on a humid surface by preventing separation caused by disconnection occurring when moisture is present on the surface of the pavement.

The asphalt composition according to the present invention, which may have the above effects, includes 60 to 93% by weight of a recycled asphalt concrete aggregate obtained by crushing or pulverizing waste asphalt concrete and 0.1 to 30% by weight of a new aggregate or a recycled aggregate for concrete.

The mixing ratio of the recycled asphalt concrete aggregate, the new aggregate or recycled aggregate for concrete, and the limestone powder is designed to conform to particle standards for normal mix prescribed in “GR F 4026:10 Recycled room-temperature asphalt concrete mixture, Section 5.”

Specifically, the particle standards of the recycled asphalt concrete aggregate per aggregate size according to KS F 2357 : 09 Aggregate for asphalt mixture, Section 5. Particle size are 40-5, 25-5, 20-5, 13-2.5, 10-0, and 5-0 by millimeter per 100% by weight of sieve. The particle standards of the new aggregate per aggregate size are 40-5, 25-5, 20-5, 13-2.5, 10-0, and 5-0 by millimeter per 100% by weight of sieve.

Also, the particle standards of the recycled aggregate for concrete per aggregate size according to KS F 2573 : 11 Recycled aggregate for concrete, Section 5. Particle size are 40-2.5 and 25-2.5 by millimeter per 100% by weight of sieve.

Additionally, a hydrophobic limestone powder is mixed, which plays a role in satisfying a porosity reference value, which is a significant quality characteristic of a mixture, is resistant to moisture susceptibility, and serves as an antiscaling agent.

The limestone powder, a Pungchon high-purity limestone deposit, which is composed mainly of calcium carbonate (CaCO₃) (50% by weight or more), is preferably prepared by containing the primary component CaO in an amount of 51.1 to 54.8 parts by weight and additives in an amount of 1.5 to 2.5 parts by weight through a crushing or pulverizing process according to particle sizes of lump, powder, micropowder, etc.

The additive is preferably any one of Al₂O₃, SiO₃, Fe₂O₃, and MgO, or a mixture of at least two thereof.

Specifically, the limestone powder is non-polar with greater affinity for oil than for water.

The limestone powder has strong hydrophobic properties forming spheres, while repelling water, rather than hydrophilic properties having minimum contact angles, while widely spreading on the surface due to high special affinity for water.

Also, as association with cell maintaining functions of hydrophobic cell membranes is reinforced, intracellular and extracellular water-soluble materials (ions or polar molecules) are not easily transplantable through unit membrane, and thus the intracellular environment remains constant.

A lipophilic group with hydrophobicity forms a chain-shaped molecular structure where carbon and oxygen are coupled to each other, like an oil component, and thus has properties of being well soluble in oil and insoluble in water.

Chemically, a nanopattern is formed on the surface, which allows widened contact area with droplets and amplified effects, thereby leading to ultrahydrophobicity. Accordingly, the limestone powder has compound-friendly, reducing, fusing, air setting, swelling, hygroscopic and deliquescent, disinfectant properties, etc.

Physically, the limestone powder has homogeneous, stable, workable, leveling, reinforcing, heat resistant insulating, sound-proof, fluorescent properties, etc.

Meanwhile, the asphalt composition according to the present invention preferably includes 3 to 7% by weight of a modified emulsified asphalt.

The inclusion of the emulsified asphalt supports the weights of vehicles and absorbs impact and deformation made from the weights, thereby achieving the effects of improved durability and performance of road pavement.

The modified emulsified asphalt includes pure asphalt in an amount of 40 to 55% by weight, so as to meet the standards prescribed in “GR F 4026: 2010 Normal mix standards for recycled room-temperature asphalt concrete mixture.”

According to the present invention, an acrylic polymer emulsion (polyacrylic emulsion) asphalt is used as a modified emulsified asphalt, thereby enhancing binding force between aggregates and filling pores, and increasing physicochemical properties including excellent cohesion, adhesion strength, flexibility, wear resistance, chemical resistance, ionic stability, physical stability, oil resistance, surface property of coated surface, etc., serving as an excellent adhesive and a coating agent for a material to be adhered by the acrylic polymer.

In other words, the acrylic polymer emulsion asphalt includes 1 to 5% by weight of an acrylic emulsion with an emulsion stabilized by raising its viscoelasticity, thereby providing the following effects of allowing high viscosity and excellent adhesion and elasticity, enhancing strength and tensile strength so that the binding force between aggregates lasts a long time and cracks are avoided, providing outstanding durability against chemical materials to protect the surface of road, and allowing durability against the volume of traffic and strong resistance to plastic deformation.

Meanwhile, the asphalt composition according to the present invention may include 3.5 to 10% by weight of a cationic emulsified asphalt alone, instead of the above modified emulsified asphalt.

The inclusion of the cationic emulsified asphalt may have the effect of maximizing the physiochemical properties, such as adhesion strength, flexibility, wear resistance, chemical resistance, ionic stability, physical stability, etc., of asphalt.

As shown in Table 2, the cationic emulsified asphalt preferably includes 40 to 52% by weight of asphalt (AP-3); 1 to 1.3% by weight of an emulsifier; 0.1 to 1.15% by weight of calcium chloride; 0.01 to 0.15% by weight of hydrochloric acid; 45 to 55% by weight of water; and 1 to 3% by weight of an acrylic polymer emulsion.

TABLE 2

| Component | Composition ratio (wt %) |
|---|---|
| AP-3 | 40 to 52 |
| Emulsifier | 1 to 1.3 |
| Calcium chloride | 0.1 to 1.15 |
| Hydrochloric acid | 0.01 to 0.15 |
| Water | 45 to 55 |
| Acrylic polymer emulsion | 1 to 3 |

The asphalt (AP3) refers to an asphalt for road pavement having a penetration level in the range of 80 to 100 according to KS M 2201 (Standards by penetration classification) and KS M 2208 (Standards by viscosity classification).

The asphalt composition according to the present invention preferably further includes 1 to 3% by weight of an additive for reclamation.

The additive for reclamation reclaims performance (increase in penetration and viscosity) of waste asphalt contained in the recycled asphalt concrete aggregate, among the components of the asphalt composition according to the present invention.

In order to further increase miscibility between the limestone powder and the aggregate, and properties of asphalt concrete, as the additive, it is preferable to use an emulsion containing a carbon component (solid content 10 to 80% by weight) with a flash point (CoC) of 218° C. or higher, a kinematic viscosity (25° C., SFS) of 15 to 85, a viscosity ratio (60° C.) after thin-film heating of 2 or lower, and a mass change rate (%) after thin-film heating of ±3 or lower.

Like the emulsified asphalt, the mixing ratio of the additive for reclamation is to satisfy stability, flow rate value, porosity, saturation, etc., prescribed in “GR F 4026:10 Recycled room-temperature asphalt concrete mixture, Section 6. Quality.”

In order to reclaim performance of waste asphalt contained in the recycled asphalt concrete aggregate through the additive for reclamation, it is preferable to include 10 to 80% by weight of a solid carbon component having strong adhesion while penetrating deeply into waste asphalt, causing no corrosion, posing coloring effects and excellent color effects without being discolored, as times pass.

The inclusion of the additive for reclamation containing the carbon component may achieve the effects of having excellent workability and adhesion strength, causing no contamination, and being harmless to humans due to dry film.

Table 3 shows the components mixing ratio of the asphalt composition according to the present invention which further includes the above additive for reclamation and emulsified asphalt.

TABLE 3

| Component | Composition ratio (wt %) |
|---|---|
| Recycled asphalt concrete aggregate | 60 to 93 |
| New aggregate or recycled aggregate | 0.1 to 30 |
| for concrete | |
| Limestone powder | 2 to 5 |
| Modified emulsified asphalt | 3 to 7 |
| Additive for reclamation | 1 to 3 |

A method for paving a road using the recycled room-temperature asphalt composition according to the present invention includes the following steps.

First, a recycled room-temperature asphalt composition is prepared by including a recycled asphalt concrete aggregate, a new aggregate or a recycled aggregate for concrete, a limestone powder, and a modified emulsified asphalt, and an additive for reclamation.

The recycled room-temperature asphalt composition is paved on a new and a repair portion of road pavement, and then compacted and cured.

Preferably, the compaction step includes a first step of four times compaction with macadam roller, a second step of eight times compaction with tire roller, a third step of four times compaction with tandem roller, and a fourth step of finishing compaction with tandem roller (combi roller), four times in total.

Next, a finishing material is coated onto the top of the recycled room-temperature asphalt composition subjected to the finishing compaction, to be cured.

For the finishing material, an acrylic polymer emulsion cationic modified emulsified asphalt or a cationic emulsified asphalt is used, and coated in an amount of 0.1 to 2.0% by weight per unit area (m²/L).

In other words, the use of the modified emulsified asphalt or cationic emulsified asphalt as a finishing material increases cohesion, physical stability, chemical resistance, surface property of coated surface, and oil resistance to oil components of roads, is also preferable in terms of environment since no dust is generated, and facilitates construction even when the pavement surface is humid.

Hereinafter, in order to investigate the effects of the present invention, exemplary experiments are described.

In order to conduct a performance test on the recycled room-temperature asphalt composition of the present invention, an asphalt composition is prepared as follows.

For the recycled asphalt concrete aggregate, and the new aggregate or recycled aggregate for concrete, an aggregate is used having a density of 2.50% or higher, an absorption rate of 3.0% or lower, and a wear rate of 40% or lower, according to quality prescribed in “KS F 2357 : 09, Section 4.” For the limestone powder, a limestone powder is used from aggregate nos. 467, 57, 67, and 78, which are appropriate aggregates according to Section 5. Standards for particle size. With the additive for reclamation and acrylic polymer emulsion cationic emulsified asphalt, the composition is mixed properly according to Particle size standards for normal mix of types in “GR F 4026: 10 Recycled room-temperature asphalt concrete mixture, Section 5.”

Also, the limestone powder significantly serves as a filler satisfying the porosity standards which are significant quality properties in road pavement. Thus, a performance test was conducted according to the quality prescribed in “KS F 3501 : 08 Filler for asphalt pavement, Section 3,” and the primary component and components contained in small amounts of the limestone powder were analyzed.

Table 4 shows a result of performance test on the limestone powder.

TABLE 4

| | | | | Test |
|---|---|---|---|---|
| Test item | Test method | Unit | Test standard | result |
| Particle-size (sieve passed | KS F 3501 | % | 100 | 100 |
| mass percentage) 600 μm | | | | |
| Particle-size (sieve passed | KS F 3501 | % | 95 or higher | 99 |
| mass percentage) 300 μm | | | | |
| Particle-size (sieve passed | KS F 3501 | % | 90 or higher | 96 |
| mass percentage) 150 μm | | | | |
| Particle-size (sieve passed | KS F 3501 | % | 70 or higher | 88 |
| mass percentage) 75 μm | | | | |
| Particle-size (sieve passed | KS F 3501 | % | — | 55 |
| mass percentage) 45 μm | | | | |
| Moisture amount | KS F 3501 | % | 1.0 or lower | 0.2 |
| Density | KS L 5110 | g/cm² | — | 2.78 |

As shown in Table 4, the limestone powder has very excellent performance satisfying porosity as a filler.

Table 5 shows a result of analysis on the primary component and components contained in small amounts in the limestone powder.

TABLE 5

| | CaO | MgO | SiO2 | Al2O3 | Fe2O3 | | Plastic | Pb | Cu | Mn | Cr | Cd | K |
|---|---|---|---|---|---|---|---|---|---|---|---|---|---|
| | (%) | (%) | (%) | (%) | (%) | Whiteness | whiteness | (ppm) | (ppm) | (ppm) | (ppm) | (ppm) | (ppm) |
| 1 | 54.6 | 0.35 | 0.03 | 0.01 | 0.04 | 95.2 | 85.8 | 8 | 4 | 102 | 3 | Tr | 177 |
| 2 | 52.4 | 2.30 | 0.27 | 0.05 | 0.12 | 90.3 | 66.7 | 17 | 4 | 178 | 5 | Tr | 267 |
| 3 | 54.3 | 0.38 | 0.07 | 0.02 | 0.04 | 94.2 | 84.6 | 9 | 3 | 127 | 5 | Tr | 164 |
| 4 | 50.7 | 2.86 | 0.57 | 0.15 | 0.26 | 73.0 | 48.2 | 36 | 6 | 295 | 4 | Tr | 443 |
| 5 | 52.7 | 2.02 | 0.03 | 0.02 | 0.09 | 93.1 | 79.2 | 16 | 4 | 204 | 4 | Tr | 169 |
| 6 | 53.7 | 1.46 | 0.17 | 0.02 | 0.08 | 89.8 | 75.1 | 14 | 3 | 226 | 4 | 2 | 178 |
| 7 | 53.6 | 0.21 | 0.10 | 0.04 | 0.06 | 90.8 | 64.8 | 2 | 3 | 189 | 5 | Tr | 188 |
| Average | 53.1 | 1.36 | 0.17 | 0.04 | 0.09 | 89.2 | 72.0 | 16.0 | 3.8 | 188 | 4.2 | 0.28 | 226 |

As shown in Table 5, it may be confirmed that the limestone powder is a high-quality limestone powder which contains a high amount of the primary component CaO and extremely small amounts of additives.

Also, it may be confirmed that the limestone powder is resistant to moisture susceptibility and very excellent in preventing scaling.

Next, for a property test on the acrylic polymer emulsion cationic emulsified asphalt, a test on quality and performance was conducted according to “KS M 2203:08 Emulsified asphalt, Section 5.”

Table 6 shows a result of quality test on the modified emulsified asphalt.

TABLE 6

| | | | Test | Test |
|---|---|---|---|---|
| Test item | Test method | Unit | standard | result |
| Engler degree (25° C.) | KS M 2203 | — | 1 to 6 | 3 |
| (viscosity) | | | | |
| Sieve residual (1.18 mm) | KS M 2203 | % | 0.3 or lower | 0.1 |
| mass | | | | |
| Binding | KS M 2203 | — | 2/3 or | 3/4 |
| | | | higher | |
| Charge of particles | KS M 2203 | — | Positive (+) | Positive |
| | | | | (+) |
| Evaporation residue mass | KS M 2203 | % | 50 or higher | 55 |
| Evaporation | KS M 2203 | — | 60 to 150 | 107 |
| residue-penetration | | | | |
| (25° C.) 1/10 mm | | | | |
| Evaporation residue- | KS M 2203 | cm | 40 or higher | 83 |
| elongation (15° C.) | | | | |
| Evaporation residue-toluene | KS M 2203 | % | 98 or higher | 99.4 |
| solubility mass | | | | |
| Storage stability (24 h) | KS M 2203 | % | 1 or lower | 0.2 |
| (mass %) | | | | |

As shown in Table 6, the modified emulsified asphalt according to the present invention conformed to all the requirements of “KS M 2203: 08 Standards for quality and performance of emulsified asphalt,” and obtained a satisfactory result in increasing durability and performance.

Here, an additive for reclamation reclaiming the performance of waste asphalt contained in the recycled aggregate for asphalt concrete was included.

For the additive for reclamation, an emulsion is used containing a carbon component (solid content 10 to 80% by weight) with a flash point (CoC) of 218° C. or higher, a kinematic viscosity (25° C., SFS) of 15 to 85, a viscosity ratio (60° C.) after thin-film heating of 2 or lower, and a mass change rate (%) after thin-film heating of 3 or lower, to stabilize the mixture with excellent cohesion and coloring effects.

Next, in order to conduct a quality test on the recycled room-temperature asphalt mixture according to the present invention, 82.0% by weight of the recycled asphalt concrete aggregate, 8.0% by weight of the recycled aggregate for concrete, 4.0% by weight of the limestone powder were mixed, and 1.7% by weight of the additive for reclamation and 4.3% by weight of the acrylic polymer emulsion cationic emulsified asphalt were added thereto, to prepare mixtures.

With regard to the thus-prepared mixtures, mixture samples were obtained based on KS F 2350 according to “GR F 4026 : 10 Recycled room-temperature asphalt concrete mixture, Section 8. Method for sampling and preparing test specimens.”

The obtained mixture samples were subjected to Marshall compaction method prescribed in “KS F 2337, Section 3.5” 75 times, to prepare test specimens. The test specimens were cured in an oven at a temperature of (60±1)° C. for 48 hours and left indoors at room temperature for 2 hours, to be de-moulded. For test, the de-moulded specimens were put into an air bath at a temperature of (25±1)° C. and remained for 2 hours. Thereafter, the stability and flow rate value of the mixtures were measured according to “KS F 2337” and the porosity of the mixtures was measured according to “KS F 2364.”

Table 7 shows a result of quality test on the recycled room-temperature asphalt mixture.

TABLE 7

| Test item | Test method | Unit | Test standard | Test result |
|---|---|---|---|---|
| Stability (25° C.) | KS F 2337 | N | 3500 or higher | 16730 |
| Flow rate value | KS F 2337 | 1/100 cm | 10 to 50 | 30 |
| Porosity | KS F 2364 | % | 3 to 12 | 5.8 |

As shown in Table 7, as a result of quality test, the recycled room-temperature asphalt mixture according to the present invention met all the quality test standards and also achieved very excellent stability and porosity.

Therefore, it may be confirmed that the asphalt mixture according to the present invention effectively prevents plastic deformation and also greatly contributes to enhancement of durability and performance.

Further, the construction method using the asphalt mixture of the present invention includes a step of finishing pavement using a modified emulsified asphalt.

The step of finishing pavement with the modified emulsified asphalt reinforces moisture susceptibility, stably protects and prolongs short lifespan of conventional pavements, and removes environmental damage caused by dust after pavement, thereby securing environment-friendly properties, while aiming at low-carbon green growth.

It should be understood that the forgoing description describes part of exemplary embodiments of the present invention by way of example only, and is not intended to limit the present invention. The above-described technical spirit of the present invention and the technical spirit sharing the basis are construed as falling under the scope of the present invention.

1. A recycled room-temperature asphalt composition, characterized by comprising:
60 to 93% by weight of a recycled asphalt concrete aggregate;
1 to 30% by weight of a new aggregate or a recycled aggregate for concrete; and
2 to 5% by weight of a limestone powder.

2. The composition of claim 1, characterized by further comprising 3 to 7% by weight of a modified emulsified asphalt.

3. The composition of claim 2, characterized in that the modified emulsified asphalt comprises 40 to 55% by weight of pure asphalt.

4. The composition of claim 2, characterized in that the modified emulsified asphalt comprises an acrylic polymer emulsion asphalt, and the acrylic polymer emulsion asphalt comprises 1 to 5% by weight of an acrylic emulsion.

5. The composition of claim 1, characterized by further comprising 3.5 to 10% by weight of a cationic emulsified asphalt.

6. The composition of claim 5, characterized in that the cationic emulsified asphalt comprises:
40 to 52% by weight of asphalt (AP-3);
1 to 1.3% by weight of an emulsifier;
0.1 to 1.15% by weight of calcium chloride;
0.01 to 0.15% by weight of hydrochloric acid;
45 to 55% by weight of water; and
1 to 3% by weight of an acrylic polymer emulsion.

7. The composition of claim 1, characterized by further comprising 1 to 3% by weight of an additive for reclamation.

8. The composition of claim 7, characterized in that the additive for reclamation comprises 10 to 80% by weight of a solid carbon component.

9. The composition of claim 1, characterized in that the limestone powder comprises 51.1 to 54.8 parts by weight of CaO and 1.5 to 2.5 parts by weight of an additive with respect to a total weight.

10. The composition of claim 9, characterized in that the limestone powder comprises a Pungchon high-purity limestone micropowder.

11. The composition of claim 9, characterized in that the additive is any one of Al₂O₃, SiO₃, Fe₂O₃, and MgO, or a mixture of at least two thereof.

12. A method for paving a road with the recycled room-temperature asphalt composition of claim 1, the method characterized by comprising the steps of:
preparing the recycled room-temperature asphalt composition;
paving the recycled room-temperature composition on a new or a repair portion of road pavement, and compacting and curing the composition; and
coating and curing a finishing material onto the top of the compacted recycled room-temperature asphalt composition.

13. The method of claim 12, characterized in that the finishing material is formed of any one of a modified emulsified asphalt formed of an acrylic polymer emulsion asphalt or a cationic emulsified asphalt, or a mixture of at least two thereof, and that the finishing material is coated in an amount of 0.1 to 2.0% by weight per unit area (m²/L) in the step of coating the finishing material.
